(19) United States
(12) Patent Application Publication
(10) Pub. No.: US 2006/0081440 A1
(43) Pub. Date: Apr. 20, 2006

(54) Clutch-release device for a friction clutch

(75) Inventors: Thomas Otto, Wurzburg (DE); Franz Nagler, Gadheim (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/251,024

(22) Filed: Oct. 14, 2005

(30) Foreign Application Priority Data
Oct. 14, 2004 (DE) 10 2004 050 185.8

(51) Int. Cl. F16D 23/12

(52) U.S. Cl. 192/99 S; 192/70.27; 192/89.24

(57) ABSTRACT

A clutch-release device for actuating a friction clutch of a motor vehicle includes a clutch-release mechanism which slides axially along a release axis and is in working connection with a release element to transmit a clutch-actuating force. The clutch-release device also has a clutch lever which pivots around a center of rotation in a pivoting plane of the lever essentially including the release axis. The clutch lever defines a force application point to the release mechanism for the transmission of the clutch-actuating force. The clutch-release mechanism and the release lever are arranged with respect to each other such that, when a release movement is performed to actuate the clutch, the radial deflection of the force application point relative to the release axis is minimized over the entire range of the release movement.

### BACKGROUND OF THE INVENTION

1. Field of the Invention

The invention pertains to a clutch-release device for actuating a friction clutch of a motor vehicle, especially for a dry friction clutch.

2. Description of the Related Art

Clutch-release devices and clutch arrangements of this type have been known for a long time in the automotive industry and can be of either the “push” type or the “pull” type.

A clutch-release device of the general type in question for actuating a pulled friction clutch is disclosed in, for example, DE 34 14 836 A1 and is illustrated schematically together with a cooperating friction clutch in FIG. 1 of the present application.

The friction clutch 1 is mounted axially between an internal combustion engine (not shown) and a transmission (also not shown) and comprises a flywheel 4, connected to the crankshaft 8 of the internal combustion engine; a pressure plate 3, which can be subjected to load by a diaphragm spring 11 in the direction toward the flywheel 4; and a clutch disk 5, which is provided with linings on both sides and is connected by a toothed hub 12 to the input shaft 14 of the transmission, guided coaxially to the clutch 1.

The clutch-release device 16 for actuating the friction clutch 1 comprises a release mechanism 18, which is supported with freedom to slide axially on a guide sleeve 7, which is held in place on the transmission housing 6 concentric to the transmission input shaft 14. At the end facing the clutch, the release mechanism 18 has a coupling element 2, by which it engages with the ends of the tongues of the diaphragm spring 11; and near the end facing the transmission, it has a flat contact surface 20, by which it engages axially with a terminal area 19 of a clutch lever 9. The clutch lever 9 is supported on the transmission housing 6 so that it can pivot around a center of rotation 22, and, in correspondence with the mechanical advantage of the lever, it transmits the actuating force introduced by the plunger 10 of an actuator (not shown) such as a pressure cylinder to the terminal area 19 in contact with the release mechanism 18, this terminal area 19 being designed as a force application point. Thus, the actuating force is ultimately transmitted to the release mechanism 18.

When the release lever 9 moves in the counterclockwise direction, the release mechanism 18 moves axially in the direction of the arrow G. As a result, the friction clutch 1 is released and the connection for rotation in common between the crankshaft 8 and the transmission input shaft 14 is broken. When the release lever 9 moves in the clockwise direction, the release mechanism 18 moves in the direction of the arrow F. The friction clutch 1 is thus engaged again, and the connection for rotation in common between the crankshaft 8 and the transmission input shaft 14 is reestablished.

The terminal area 19 of the clutch lever 9, i.e., the area which acts on the release mechanism, and the contact surface 20 are arranged in pairs around the transmission input shaft 14 or around the stationary sleeve 7 to guide the movement of the release mechanism 18. It can also be seen that each of the terminal areas 19 of the clutch lever 9 in contact with the release mechanism 18 has a convex cam 21, at least part of which is circularly cylindrical. The cams rest on the contact surfaces 20 of the release mechanism 18, as a result of which line contact is ideally established at the contact location between the cam 21 and the contact surface 20. To produce the strongest possible release force, the arm 24 of the clutch lever 9 acting on the actuator is much longer than the lever arm 26 acting on the cam 21.

The applicant of the publication cited above has been mass-producing these types of clutch-release devices for several years. The cam which acts on the release mechanism of the device usually has a radius R of 12 mm (cam radius).

When the friction clutch is released, the kinematics of the clutch-release device are determined by the circular path which the cam describes around the center of rotation of the clutch lever and by the axial movement which the clutch-release mechanism executes on its guide tube. The result is that the contact point, that is, the force application point to the clutch-release mechanism, is not fixed in space but rather shifts both on the radial contact surface of the clutch-release mechanism and on the surface of the cam as the release movement progresses. This movement of the contact point results from the superimposition of a rolling movement and a sliding movement of the cam 21 in the radial direction with respect to the axis of the release mechanism. When the circular path is broken down into components and expressed in Cartesian coordinates, this sliding movement represents a component which acts transversely to the axis of the release mechanism. As a result of the release mechanism preload force acting as a normal force, this sliding component causes a transverse force to act on the release mechanism and thus also on the guide tube. At the same time, as a result of the radial displacement of the contact point and of the actuating force, which thus acts at an angle to the axis of the release mechanism, a tilting moment is exerted on the release mechanism. This tilting moment leads to undesirable frictional losses between the release mechanism and the guide tube.

To avoid these frictional losses and possible self-locking and clamping effects, the known clutch-release mechanism is designed so that, in the new state, the contact point at which the force is introduced to the release mechanism when the clutch is actuated is as close as possible to the axis of the release mechanism and remains as nearly as possible in the same radial position relative to that axis over the course of the release movement. In this case, the curved path alone, which the force application point deflects during a release movement, describes a segment of a circle, which includes a point at which the radial displacement reaches a local maximum, that is, the zenith. Thus, when the clutch lever pivots, the axial component of the circular path required for the release movement is maximized, and the radial component is simultaneously minimized. Over the course of the release distance which the release mechanism must travel to ensure the reliable release of the friction clutch, the curved path of the contact point is approximately symmetrical to a lateral plane of the release mechanism axis, as can be seen in FIG. 2, which shows the radial displacement of the force application point delta y as a function of the release distance traveled in the axial direction over a release stroke of 14 mm. Zero on the abscissa represents geometrically the course of the axis of the release mechanism. In the starting position of the release mechanism, that is, at the beginning of a clutch release operation, the contact point deviates approximately 2.5 mm from the release mechanism axis, and, when the clutch is completely released, it deviates approximately 2.7 mm from the release mechanism axis. The maximum position is approximately 3 mm, from which we can calculate in this example that the maximum radial displacement over the course of a release stroke is 0.5 mm.

The basic idea according to the state of the art explained above suffers, however, from the decided disadvantage that the transverse force acting on the release mechanism reverses direction during the course of a release stroke and thus leads to a discontinuity in the course of the movement, which the driver perceives as an annoying characteristic of clutch pedal behavior and which can exert negative effects on the automatic control of an actuator. In the technical literature on the subject, the totality of the discontinuities associated with this behavior has become known as “harsh engagement”.

FIGS. 3A, 3B and 3C show the release force at a clutch, the pneumatic pressure in a pressure cylinder, and the plunger force of the release cylinder versus the release distance over the course of a single actuation cycle, that is, over the course of the release and engagement of a clutch-release device according to the state of the art. The discontinuity points are in the area of the extreme values of the curves enclosed by the dotted line. The hysteresis in the force and pressure curves reflects the friction processes between the elements engaging with each other in the overall system.

The release distance range to be reserved for a release mechanism 18 on the sliding sleeve 7 is determined not only by the release stroke of approximately 12-14 mm, for example, required to release the clutch, but also by a wear distance and a tolerance distance range. The wear distance, which can be a maximum of 17 mm in the following example according to FIG. 4, results from the decrease in the thickness of the clutch lining. The longer the friction clutch is used, the thinner the lining becomes, and this decrease leads to an axial displacement of the pressure plate toward the flywheel and thus to a tipping of the diaphragm spring. As a result, the axial position of the release mechanism undergoes a continuous change in proportion to the mechanical advantage of the diaphragm spring, and the release distance range is shifted continuously in the axial direction. In the release device shown in FIG. 1, the release mechanism migrates toward the clutch as the lining wears down. The tolerance distance range takes into account the tolerances allowed for the installation dimensions of the clutch and of the release device, which can in the normal case be approximately 10-20 mm. The release distance, the wear distance, and the tolerance distance range define in sum a total release range of approximately 40-50 mm.

The axial position of the release mechanism, in which the previously described reversal of direction of the transverse force occurs, therefore depends on the wear state and on the associated axial displacement of the release stroke within the release distance range and also on the tolerances allowed for the installation dimensions of the clutch. For these reasons, the position of the transverse force reversal point (harsh engagement point) cannot be determined in advance, in addition to which it also changes as the wear distance of the clutch changes.

For a cam radius R of 12 mm and an effective lever length L of 23 mm, FIG. 4 shows the resulting curved path “a” of the force application point and three different axial installation points A, B, C of a release mechanism within the tolerance distance range, these points representing the engaged state of a new clutch, i.e., the closed state in the normal case. A release stroke of 12 mm with an additional reserve of 2 mm, that is, a total stroke of 14 mm, can be realized. The reserved wear distance here is 17 mm. In the new state, the mechanism will traverse the sections AA′, BB′, or CC′, depending on the position in which the release mechanism is installed. The resulting radial displacement delta y of the force application point with respect to the axis of the release mechanism is found from the difference between the minimum and maximum position of the force application point of the associated section of curve “a”.

In the case of a new clutch installed at the limit of the tolerance range as shown on the right in FIG. 4, the curve AA′ extends only in the upper half-plane, where the force application point at the beginning of the release movement is located 2.6 mm from the release mechanism axis and, when the clutch is completely released, 2.8 mm from the axis. The force application point reaches a maximum distance of 3.0 mm from the release mechanism axis, from which we obtain a radial displacement of 0.4 mm.

It can be seen from FIG. 4 that, when the tolerance distance range is exhausted, the radial displacement of the force application point over the course of a release stroke increases continuously with increasing clutch wear. At the end of the service life of the lining, this displacement reaches 4.8 mm in the least favorable case. The force application point now passes over the zero position, that is, the axis of the release mechanism, during the release stroke. The transverse force component acting on the release mechanism therefore becomes stronger as the operating time increases, which leads to increased frictional losses and to a deterioration in the smoothness of actuation.

Because of the tight spaces present in a motor vehicle, the design of the lever cannot be changed. That is, the length of the lever arm acting on the release mechanism cannot be lengthened to “flatten” the pivot curve.

### SUMMARY OF THE INVENTION

An object of the present invention is to reduce by simple means the disadvantageous effects (harsh engagement) resulting from the interaction of the clutch lever with the release mechanism.

The inventors first arrived at the fundamental realization that the radial displacement of the force application point delta y can be considered a measure of the harsh engagement effect. Starting from there, it was found that, for the optimization of the release operation and thus of the kinematics of the clutch lever and release mechanism, it is not enough to consider just the curve of the release stroke in the new state traveled by the force application point in the most favorable installation position with respect to installation tolerances and that, on the contrary, it is also necessary to consider the entire release distance range of the release mechanism from the beginning to the end of its service life, that is, including the component of lining wear and including an installation tolerance.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a schematic partially sectioned axial view of a clutch-release device for a friction clutch;

FIG. 2 is a graph illustrating radial displacement of a force application point (delta y) between a cam of an actuating lever transmitting a clutch release force and a clutch-release mechanism over a course of the release stroke of the clutch-release mechanism and a wear distance;

FIG. 3A is a graph showing distribution of a release force acting upon a friction clutch over a course of a single actuation cycle of the clutch-release mechanism;

FIG. 3B is a graph showing distribution of a pneumatic pressure in a pressure cylinder over the single actuation cycle of the clutch-release mechanism;

FIG. 3C is a graph showing distribution of a plunger force over the single actuation cycle of the clutch-release mechanism; and

FIG. 4 is a graph showing displacement of the force application point between a cams having a radii of 12 mm, 1 mm, and 16 mm, and an associated surface of the clutch release mechanism over the entire release range of the clutch-release mechanism.

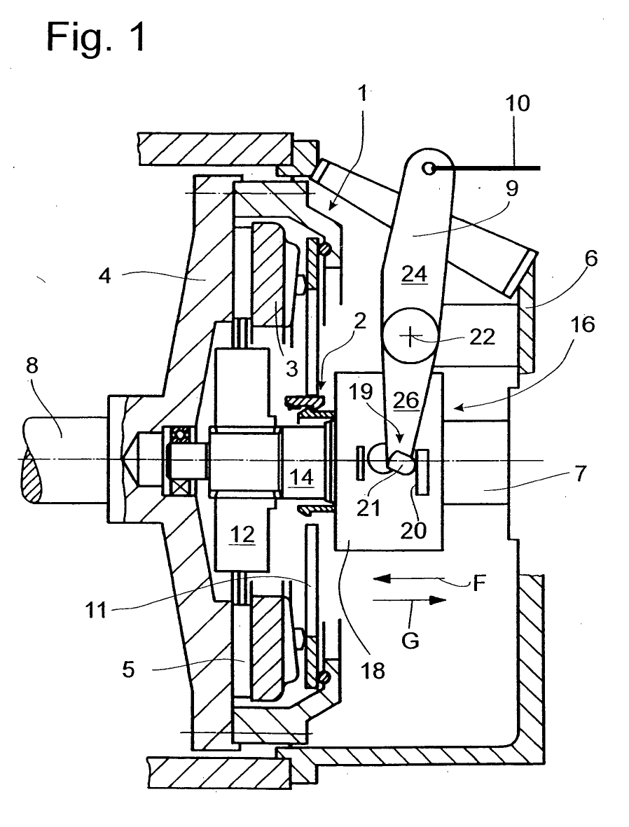

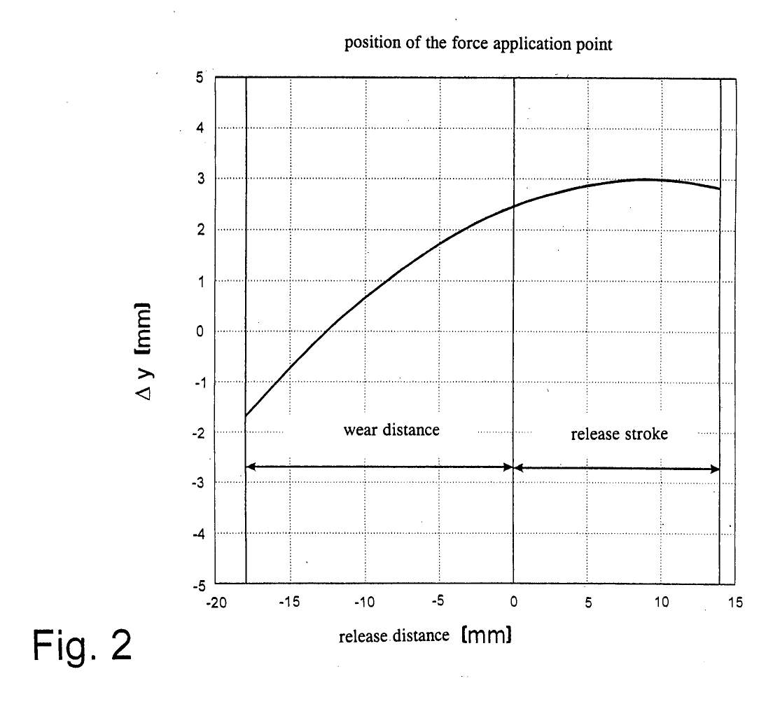

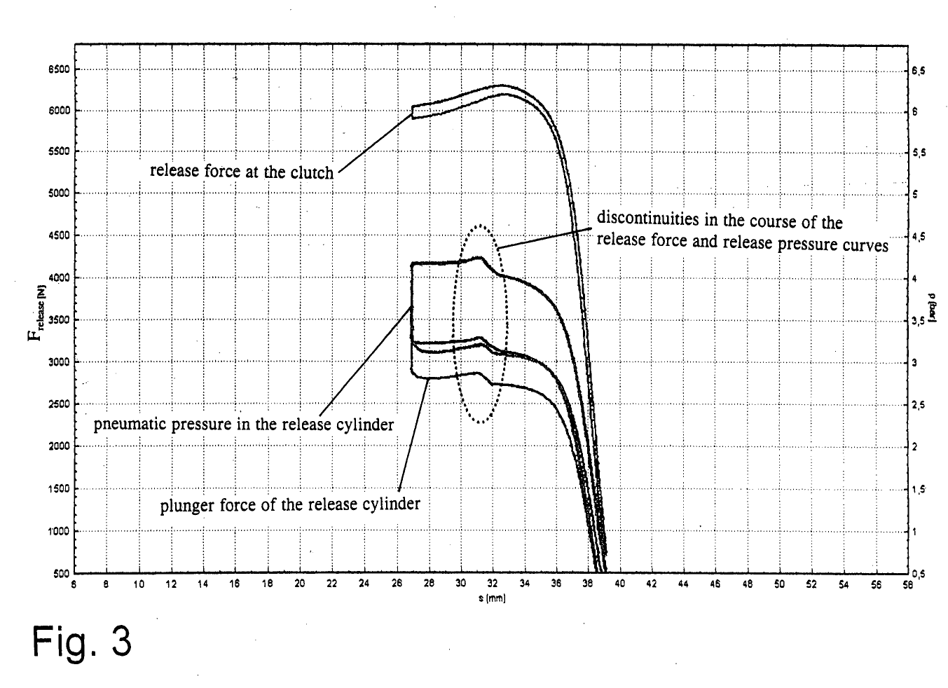

### DETAILED DESCRIPTION OF THE PRESENTLY PREFERRED EMBODIMENTS

As a way of minimizing the harsh engagement effect, that is, of minimizing the radial displacement of the force application point, it is proposed that the release mechanism and the release lever be arranged with respect to each other in such a way that, upon execution of a release movement for actuating the clutch, the resulting radial displacement (delta y) of the force application point with respect to the release mechanism axis is minimized over the entire release range, which is determined by the length of the release stroke required to actuate the friction clutch and by a clutch wear distance and/or a tolerance distance range.

For this purpose, it is possible, for example, in the case of a given clutch lever with a fixed center of rotation and arms of fixed lengths, to reduce the radius of the cam in comparison with the state of the art, where the resulting elevated surface pressure at the contact point, which depends on the materials being used, represents a limiting factor.

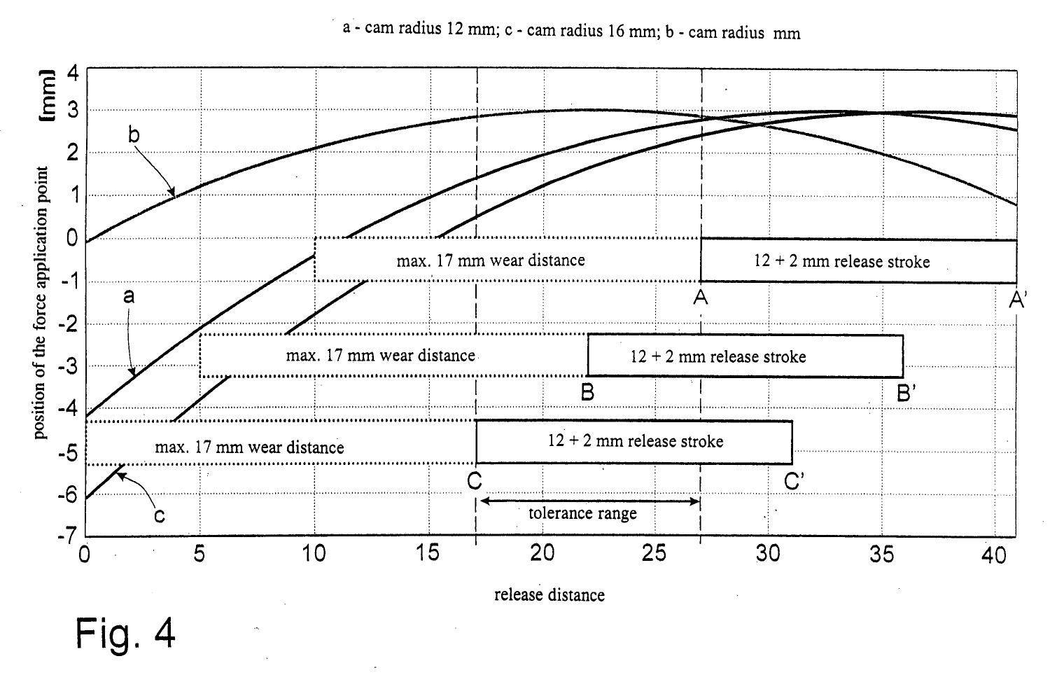

To obtain curve “b” in FIG. 4, the radius of the cam was reduced to 1 mm, which, in the new state of the clutch, leads upon travel of the release distance AA′ to a radial displacement delta y of approximately 2.1 mm. Although this is greater than that of curve “a”, the maximum displacement expected throughout the entire service life is only 2.7 mm, which is only about half the maximum displacement of curve “a”, which translates to a considerable reduction in the harsh engagement effect. For comparison, curve “c” represents the curve of the contact point obtained with a cam radius of 16 mm.

The release device can be optimized advantageously as a function of the length L of the clutch lever acting on the contact point, that is, as a function of the pivot radius acting on the release mechanism, as follows:
for L<60 mm→L/R=30 . . . 60
for L≧60 mm and L<100 mm→L/R=20 . . . 80
for L≧100 mm→L/R=100,
where R=the radius of the cam on the clutch lever.

As an alternative to reducing the radius of the cam, the center of rotation of the clutch lever can also be shifted axially with the same effect, but in individual cases this can be more difficult or even impossible to realize as a result of limited space inside the clutch bell. For example, instead of decreasing the radius of the cam, the center of rotation can be shifted toward the clutch to obtain the desired effect.

According to another embodiment of the present invention, the geometry of the contact area between the clutch lever and the release mechanism is modified in such a way that the laws which describe gears come into play, as a result of which the effect of the reversal of the transverse force on the release mechanism can be reduced. The cam 21 and contact surface 20 can thus be designed as the flanks of gear teeth and be of such a nature that movement is transmitted uniformly from the clutch lever to the release mechanism, in that the two elements move as if only their pitch or rolling circles are in contact and in that they have the same circumferential velocity at the contact point. Numerous variants are known to the expert in the gear field, such as elements designed as involute, cycloid, or lantern wheel drive gears. Accordingly, having the cam 21 designed as one of the involute, cycloid or lantern pattern substantially reduces radial displacement of the application force.

In the case of a clutch with a wear take-up device and/or with an adjusting device for compensating for the tolerances of the installation dimensions, additional design possibilities are created as a result of the decrease in the release distance range required for the release mechanism. For example, it is possible in this case to place the reversal point of the transverse force on the axis of the release mechanism. In addition, the curve of the contact point can be located with respect to the release mechanism in such a way that the curve described during a release operation lies either completely in front of or behind the reversal point.

By way of elaboration it is proposed that the curve be located so that, with respect to the release mechanism axis, it lies during a release operation inside a radial range between the release mechanism axis and the reversal point, that is, the point of maximum radial deviation delta y.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch release device for actuating a friction clutch in a motor vehicle in response to an actuating force from a clutch actuator, comprising:
a clutch-release mechanism slidable along a release axis and connectable with a release element of the friction clutch for transferring the clutch actuating force to the release element; and
a clutch lever supportable relative to the motor vehicle for pivoting about a center of rotation in a pivoting plane essentially including said release axis, said clutch lever including a first force application section arranged and dimensioned for receiving the clutch actuating force from the clutch actuator and a second force application section connected to said clutch-release mechanism and defining a force application point on said clutch-release mechanism through which said clutch actuating force is transferred to said clutch-release mechanism,
said clutch-release mechanism being arranged relative to said clutch lever such that a radial deflection of the force application point relative to said release axis is minimized over the entire range of a release movement, wherein the range includes a release stroke required to actuate the friction clutch and at least one of a clutch wear distance range and tolerance distance range.

2. The clutch-release device of claim 1, wherein said second force application section includes a cam surface contacting a contact surface on said clutch-release mechanism, at least one of said cam surface and said contact surface being involute-, cycloid-, or lantern-shaped.

3. The clutch-release device of claim 1, wherein said second force application section includes a cam surface contacting a contact surface on said clutch release mechanism, said cam surface having a radius of curvature sized for minimizing the radial deflection of the force application point relative to said release axis over the entire range of the release movement.
